(19) United States
(12) Patent Application Publication
(10) Pub. No.: US 2024/0229497 A1
(43) Pub. Date: Jul. 11, 2024

(54) Combined Vehicle Canopy and Tent

(71) Applicants: Lun Xu, Pasadena, CA (US); Xuduo Wen, Pasadena, CA (US)

(72) Inventors: Lun Xu, Pasadena, CA (US); Xuduo Wen, Pasadena, CA (US)

(21) Appl. No.: 18/095,087

(22) Filed: Jan. 10, 2023

(51) Int. Cl. E04H 15/06; E04H 15/10; E04H 15/42

(52) U.S. Cl. CPC E04H 15/06; E04H 15/10; E04H 15/425

(57) ABSTRACT

A combined tent and tent canopy for use with motor vehicles is disclosed. The combined tent and tent canopy includes a tent structure formed using a plurality of flexible poles; a tent cover section that is attached to the plurality of flexible poles; and at least one extendable cover canopy sleeve section extending from the top and sides of the tent cover section. The extended canopy sleeve sections are configured to be connectable to a motor vehicle and thereby provide a covered connection to the motor vehicle. As used in connection with a sport utility vehicle or a mini-van, the combined tent and tent canopy provides a covered extension to the interior of the vehicle. The combined tent and tent canopy further incorporates a plurality of tie-down lines to anchor the tent and canopy to the ground and/or to the vehicle, to secure the tent and tent canopy structure.

### BACKGROUND

Tents and tent-type structures are widely used in a very broad spectrum of applications. Indeed, tents are used for a multitude of activities including applications such as camping, beach time, sun protection, wind and rain protection, play tents, pet enclosures, and even shower or changing enclosures. Depending upon the design and covering, such structures and coverings provide protection from wind, rain when used for outdoor camping, and especially in the beach environment, protection from the sun and ultraviolet light. One important feature for most all tent structures used in an outdoor temporary setting is that the structure must be readily portable so that it can be transported to where it will be used, and readily storable when not in use.

While camping and beach tents have been designed and used as independent structures in many forms and varieties, the use of a tent structure in combination with a motor or electric vehicle, including as an extension to the interior of the vehicle has been limited. Such limited designs are in part because of the wide variety of vehicle configurations and designs have prevented a universal design. Moreover, structural materials have evolved that now allow tent structures and systems to be flexible in terms of assembly, disassembly, portability, storage, and utility.

Different types of tent-type structures have been created and commercialized to address some of these concerns and issues. While there have been many such designs, and indeed, new designs continue to evolve, none appear to provide an optimal or even widely accepted solution for a tent structure that can be effectively used as a canopy with or over a motor vehicle, and provide an extension to the interior of the motor vehicle, and still retain the key and core features of being lightweight, easily transported, readily storable, easily assembled, and easily disassembled. While some designs provide for some flexibility with respect to the structure and size of the tent, such size and configuration flexibility is very limited, and generally does not provide ready means for using a tent structure with an integral canopy attachable to different motor vehicle configurations, designs, and sizes.

One example of such a prior art system includes U.S. Pat. No. 6,070,925 for a Tent Assembly For Use With A Vehicle, by Moldofsky. The Moldofsky '925 patent, discloses a tent assembly having a plurality of support members connected to one another to form a frame, along with a cover material, and a sleeve structure connected to the covering material with flexible sidewalls of the sleeve structure extending outwardly. The Moldofsky patent discloses a tent structure that appears to allow for connection of a tent sleeve to the rear portion of a vehicle, and specifically provides for the use and need of an elongated length of compressible material, such as foam or sponge material to resiliently compress inwardly against an outer surface of the vehicle the sleeve is attached to.

Accordingly, it would be useful to have a portable tent and canopy structure that can be used in connection with different motor or electric vehicles to provide an extension of the interior of the vehicle, and also is adjustable such that the combined tent and canopy structure is easily portable and readily used with different vehicles. Such an innovative tent structure could include, in addition to the integral canopy sleeve, adjustability for different vehicle configuration and sizes, as well as additional features such as roof sections having transparent sections to allow for night sky viewing, and photovoltaic panels with batteries and lighting elements to enhance the utility of the tents within the vehicles.

The combined tent and canopy structure should be easily assembled or deployed, and easily disassembled. Moreover, the tent/canopy structure should be lightweight, and in the disassembled or folded configuration, be easy to store and transport. Such a combined tent and canopy structure does not appear to have been designed, developed, or commercialized that satisfactorily meets each of these criteria. While certain of these problems may be addressed by one or more examples of the prior art, a complete solution to all of these problems does not appear to have been specifically designed or used in the relevant prior art.

### SUMMARY OF THE INVENTION

The present invention overcomes the disadvantages of the prior art and fulfills the needs described above by providing a combined tent and canopy structure for use with motor vehicles that includes a plurality of flexible ribs, a flexible cover that forms a main tent section and a canopy sleeve wrapping about part of the motor vehicle.

One preferred embodiment of the invention is a combined tent and canopy structure for use with motor vehicles, comprising a plurality of flexible ribs that form a skeletal shape for a main section of said tent structure; a flexible cover attachable to said plurality of flexible ribs to form said main section of said combined tent and canopy structure, and forming at least one canopy sleeve section extending from sides of said tent main section, wherein at least one canopy sleeve is sized to encircle a section of said motor vehicle; a plurality of connecting straps, having an adjustable strap length, wherein one end of each of said plurality of connecting straps is attached to said flexible cover, and wherein the opposite end of each of said plurality of connecting straps is attachable to a fixed element of said motor vehicle, such that when said plurality of connecting straps are connected to said motor vehicle, a connecting canopy is formed between said main section of said tent structure and said motor vehicle; and a plurality of tie-down elements to attach said plurality of flexible ribs and said flexible cover to a stable element.

A second preferred embodiment of the invention is a combined tent and canopy structure for use to extend the interior of motor vehicles, comprising a tent main section formed from a plurality of flexible ribs; a tent cover attachable to said plurality of flexible ribs; at least one canopy section formed from a canopy cover integrally attached to and extending away from a side of said tent cover, wherein a distal end of said canopy cover encircles a section of said motor vehicle and provides a covered area between the interior of said motor vehicle and the interior of said tent main section; a plurality of connecting straps, having an adjustable strap length, wherein one end of each of said plurality of connecting straps is attached to said tent cover or canopy cover, and wherein the opposite end of each of said plurality of connecting straps is attachable to a fixed element of said motor vehicle; and a plurality of tie-down elements to attach said plurality of flexible ribs and said tent cover to a stable element.

A third preferred embodiment of the invention is a combined tent and canopy structure for use to extend the interior of motor vehicles, comprising a tent main section formed from a plurality of flexible ribs; a tent cover attachable to said plurality of flexible ribs; two canopy sections formed from two canopy covers each integrally attached to and extending away from a side of said tent cover, wherein a distal end of each said canopy cover encircles a section of said motor vehicle and provides a covered area between the interior of said motor vehicle and the interior of said tent main section.

### BRIEF DESCRIPTION OF THE DRAWINGS

To easily identify the discussion of any particular element or act, consistent element numbers refer to such elements in different figures.

FIG. 1 is a perspective or isometric front view of an embodiment of the inventive combined tent and canopy structure shown as assembled with the canopy extended.

FIG. 2 is a perspective or isometric front view of an embodiment of the inventive combined tent and canopy structure shown as assembled and with the canopy retracted against the main tent section.

FIG. 3 is a side view of an embodiment of the inventive combined tent and canopy structure shown with the canopy end open.

FIG. 4A is a perspective or isometric front view of an embodiment of the inventive combined tent and canopy structure shown as assembled and attached to a motor vehicle.

FIG. 4B is a perspective or isometric front view of an embodiment of the inventive combined tent and canopy structure shown as assembled, attached to a motor vehicle, and secured to the motor vehicle and the surrounding ground.

FIG. 4C is a perspective or isometric front view of an embodiment of the inventive combined tent and canopy structure shown with two canopy sections, as assembled and attached to two opposing motor vehicles.

FIGS. 5A through 5F show a series of views illustrating disassembly, folding and storage of an embodiment of the inventive combined tent and canopy structure.

FIG. 6 is a perspective or isometric view of an embodiment of the inventive combined tent and canopy structure shown with a transparent section in the tent main section roof for stargazing.

FIG. 7 is a perspective or isometric view of an embodiment of the inventive combined tent and canopy structure shown with photovoltaic (“PV”) solar panels, lighting elements, and electrical storage batteries.

FIG. 8 is a perspective or isometric view of an embodiment of the inventive combined tent and canopy structure shown with heat generators within the sides and floor of the tent.

FIG. 9 is a perspective or isometric view of an embodiment of the inventive combined tent and canopy structure shown with a cover sheet over the main tent section and canopy section.

### DETAILED DESCRIPTION OF CERTAIN EMBODIMENTS

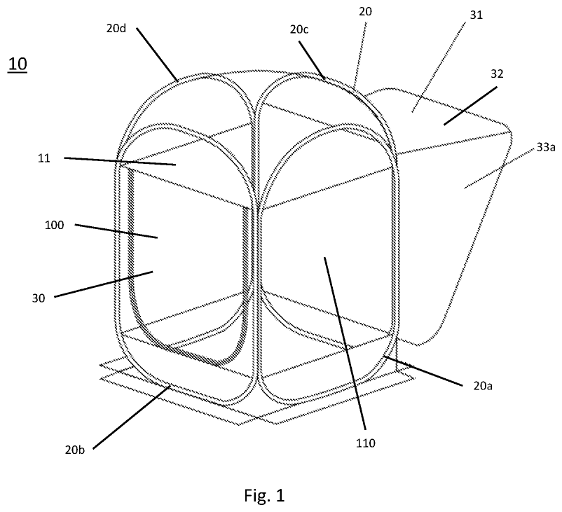

An innovative tent structure with one or more integral canopies for use with motor vehicles is disclosed and described in various relevant and useful embodiments. The combined tent and canopy structure 10 is shown in different embodiments in FIGS. 1 through 9.

At its core, the combination tent and tent/vehicle canopy structure 10 is comprised of a plurality of flexible ribs 20, a cover 30 that is attachable to the plurality of flexible ribs 20, with the cover 30 including at least one integral canopy section 31, a plurality of connecting straps, attachment lines, or guy lines 40 to secure and stabilize the tent and canopy structure 10, and a plurality of cover fasteners 45 used to attach the canopy section 31 to the adjacent vehicle.

As shown, in one embodiment in FIGS. 1 through 3, the tent and canopy structure 10 includes a plurality of flexible ribs 20a, 20b, 20c, 20d that form the skeletal support structure of a main tent section 11 when assembled and deployed, and to which the cover 30 is attached. A core element of the tent and canopy structure 10, is the canopy section 31, as shown in one embodiment in FIG. 1, that is integral to the cover 30. More particularly, the canopy section 31 in one embodiment has a sleeve shape and design, as shown in FIG. 1, that may be comprised of a canopy roof section 32 and canopy side sections 33a, 33b.

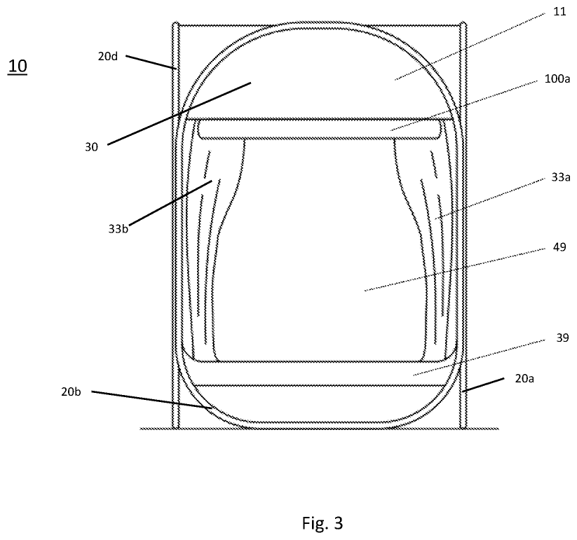

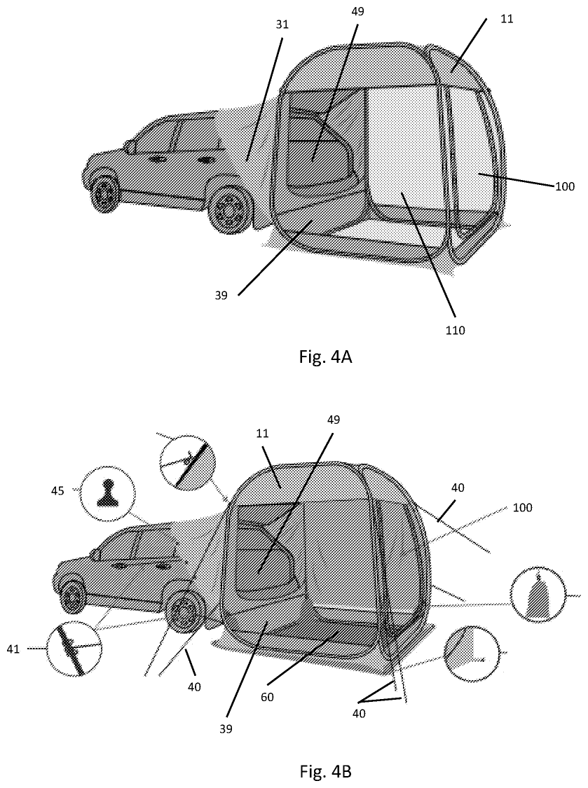

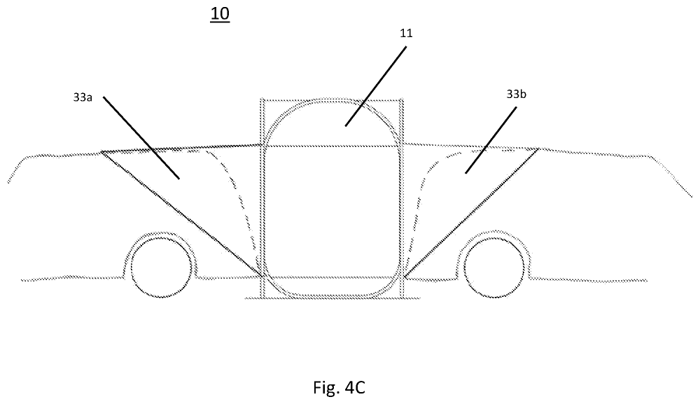

As deployed, the canopy section 31 is configured to encircle a section of an adjacent vehicle, as shown in FIGS. 4A, 4B, with the canopy roof section 32, and canopy side section 33a, 33b extending away from main tent section 11 and attaching respectively to the roof and sides of the vehicle. In the fully assembled and deployed configuration, as shown in FIGS. 4A, 4B, with the tent and canopy tent structure 10 attached to the vehicle, the canopy section 31 envelops the tail end of the vehicle, shown as a sport utility vehicle, similar to a sleeve, and provides a covered extension of the main tent section 11 into the vehicle, and likewise an extension of the interior of the vehicle 49 (also noted in FIG. 3) into the main tent section 11. As shown, this extension is in part provided because the tent structure 10 and canopy section 31 allow for the vehicle cargo hatch to open up into the canopy section 31.

As shown in FIGS. 4A and 4B, the tent and canopy structure 10 may be attached to the vehicle and secured in place using a plurality of connecting straps 40, or attachment lines 40, and guy lines 40, along with a plurality of cover fasteners 45. The cover fasteners 45 may be magnetic connectors or another type of clips or fasteners that can be readily attached and removed from the vehicle. As shown in FIG. 4B, the attachment lines may be attached to various solid locations on the vehicle including wheels or tire hubs, or door handles. To allow for use of the tent and canopy structure 10 with different types and sizes of vehicles, the connecting straps 40, or attachment lines 40, may be adjustable in length using a standard buckle mechanism 41. FIG. 4B also shows deployment and use of a plurality of tie-down lines 40 or guy lines 40 to secure the main tent section 11 to the ground surrounding the tent and canopy structure 10.

Magnets or magnetic connectors 45 are effective because such pieces provide a secure attachment of the cover 30 to a metallic vehicle surface, and will not mar or damage the vehicle surface to which the cover 30 is attached.

While not shown in FIG. 4A or 4B, the embodiment of the tent and canopy structure 10 could have two or more adjustable length connecting straps 40, such that there is at least one connecting strap 40 on each side of the tent and each side of the canopy section 31. Such a configuration allows the user to orient or tilt the canopy section 31 to the left or right, and be aligned with the vehicle.

The adjustable length connecting straps 40 may be manufactured from a wide variety of materials including textile, such as woven polyester, which is very flexible and lightweight; or composite material such as high tensile strength polyester yarn encased in a weatherproof coating of polypropylene. Other potential materials for the connecting straps 40 are bungee cords or elastic rope, or simply a rope or other guy line material.

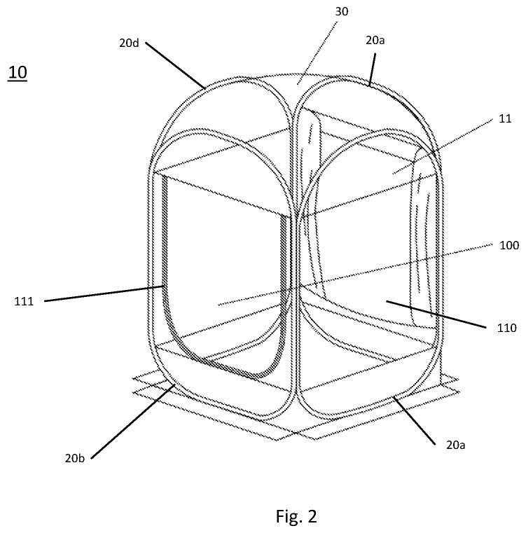

The versatility of tent and canopy structure 10 design is that the structure may also be effectively used without attachment to a vehicle. As shown in FIG. 2, the tent and canopy structure 10 may be configured and used with the canopy section 31 rolled up or stored proximate to the main tent section 11. As shown, the adjustable length connecting straps 40, in preferred embodiments of the tent structure 10, along with one or more collecting loops 42 may be incorporated as part of the canopy section 31, or as part of the main tent section 11, to allow the user to roll up, or fold up, the canopy section 31 and neatly held in place by the connecting straps 40 and collecting loops 42.

The collecting loops 42 may be formed from standard hook and loop textile materials to allow for easy collection and storage of the additional cover material, and then easy release of the canopy section 31 when the tent structure 10 is deployed and attached to a motor vehicle, as shown in FIGS. 4A and 4B.

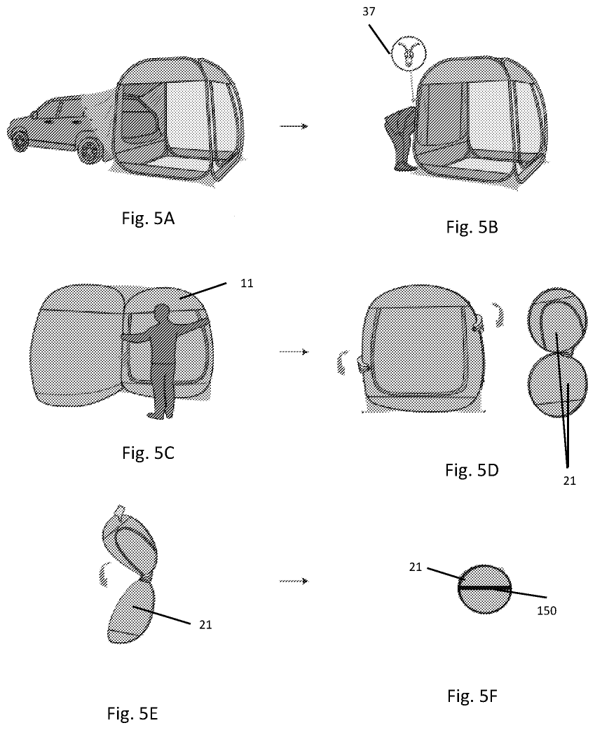

In a further configuration, as shown in FIG. 5B, the canopy section 31 may be fully stored in place, and thereby form a side of the main tent section 11. In this set-up configuration, the tent and canopy structure 10 is more like a traditional portable tent.

In the embodiments shown in FIGS. 1 through 3, the flexible ribs 20a, 20b, 20c, 20d that form the skeletal structure for the tent structure 10, are single element ribs. In another embodiment, the flexible ribs 20 may be formed from a plurality of sub-support rib sections that are interconnected to form the flexible ribs 20.

The cover 30 may be attached to the flexible support ribs 20a, 20b, 20c, 20d through the use of various fasteners 24. Such fasteners could be, in different embodiments, textile hook and loop sections and/or tie ends. In another embodiment, the cover 30 may be formed with sleeve sections 25 through which the flexible ribs 20 are able to readily slide to form the tent structure 10.

To allow for ease of use and comfort, as shown in FIGS. 1 through 5F, and particular FIG. 3, the tent and canopy structure 10 may also incorporate one or more door sections 100 and window sections 110. The door section 100 may be opened or closed through fasteners 111, which in one embodiment as shown in FIGS. 1 and 2, may be a zipper 111. Similarly, the window section 110 may be opened or closed through use of fasteners 111, which in one embodiment may again be a zipper 111. Alternative forms of fasteners that may be equally applicable and useful are snaps, buttons, or attracting magnet elements that are embedded into the cover 30 and door section 100 or window section 110 edges, or hook and loop textile material or strips.

The door 100 and window 110 sections may be incorporated into the flexible cover 30 in a variety of configurations. For example, FIGS. 1 and 2 show a window 110 within a side panel. Alternatively, as shown in FIG. 2, the window section 110 could be included within the door section 100 as part of transparent door 100, or as part of a side panel of the tent structure 10.

While shown in FIGS. 1 through 4B with a single canopy section 31 incorporated as part of the tent and canopy structure 10, in other embodiments, the main tent section 11 and cover 30 may be manufactured with two or three canopy sections 31a, 31b, 31c, as shown in FIG. 4C. In such an embodiment, multiple users or families may “tailgate” and commune their vehicles around a single main tent section 11 that forms a common area for all users.

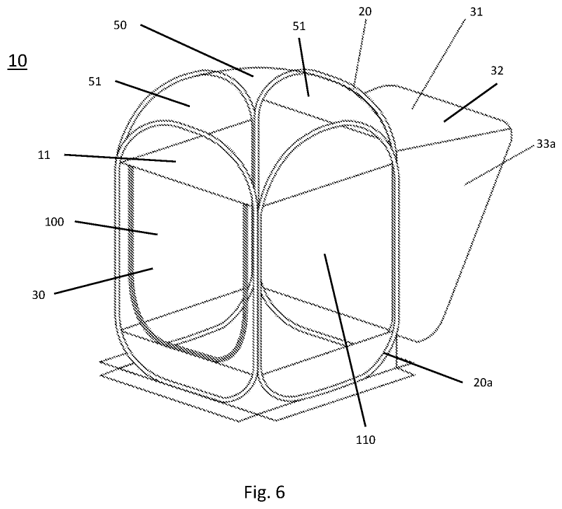

A further feature of the tent and canopy structure 10 may be the use of one or more sections 51 in the tent structure 10 roof section 50, that are transparent to allow unaided viewing of the night sky, as shown in FIG. 6. In a preferred embodiment, the transparent section 51 of the upper section 50 should be at least 25% of the total area of the tent structure roof section 50, but may encompass the entirety, or the substantial entirety of the tent structure 10 roof section 50.

As shown, the door section 100, once unzipped, or unfastened, may be readily rolled up towards the top of the tent structure, and secured in the rolled up configuration 100a, to allow open access into the tent and canopy structure 10. Similarly, the window section 110, once unzipped, or unfastened, may be readily rolled up or down, depending upon the window orientation, to allow air to flow into or out of the tent and canopy structure 10. In the embodiment shown, with the window section 110 open, wind and air flow are allowed to pass into the tent structure 10, but still provide a high level of protection from sand or other wind-blown objects. Such window sections 110 also allow users to see out of the main tent section 10.

Disassembly or collapsing of the tent and canopy structure 10 into a convenient transportation or storage configuration is easily achieved, as illustrated in FIGS. 5A through 5F. First, the adjustable connecting straps 40, cover fasteners 45, and guy-lines 40 are removed to allow the tent structure 10 to be moved. Next, as shown in FIG. 5B, the canopy section 31 is stored in placed as part of a side of the main tent section 11, and then fastened in place as part of the main tent section. As illustrated, the fastening in place of the canopy section 31 may be through use of one or more zippers 37 or other similar fastening elements such as hook and loop textiles, snaps, or buttons. The main tent section 11 sides are then aligned and folded on top of each other in a layer fashion as shown in FIGS. 5C and 5D.

Next, the main tent section 11 layered or stacked sides may then be readily collapsed by pulling opposite sides of the “circles” together to create an hour-glass shape or figure eight shape, as shown in FIG. 5D. Then with a slight twisting motion, one half of the figure-eight shape is folded on top of the other half of the figure-eight shape, as shown in FIG. 5E, to form essentially a disc configuration as illustrated in FIG. 5E. The number of discs is dependent upon the number of main tent section 11 sides that make up the tent and canopy structure 10. More particularly, for a tent with four sides, as shown in FIGS. 5A and 5B, there will be eight discs in the disassembled, and folded configuration, while for a tent with three sides (not shown), there will be six discs in the fully folded configuration. When fully collapsed, the tent and canopy structure 10 is fairly compact, and may be placed within a bag or sack 210 (not shown), that may be shaped to properly fit the folded tent structure.

Once in the “discs” or collapsed configuration, a strap or other securing element 150 may be used to keep each of the discs in place adjacent to and in relation to each of the other discs as shown in FIG. 5E. Alternatively, there may be clips, hook and loop (Velcro®) pieces, buckle, button, clasp, snap, or other similar type of securing element or mechanisms 150 that can be used to maintain the discs in approximate position next to each other in the folded configuration.

The assembly or setup of the tent and canopy structure 10 is undertaken in the opposite steps to that described above for disassembly. The securing mechanisms or clips 150 may be released to allow the discs to separate from each other. With a little urging, each of the discs 21 may be untwisted and unfolded to form the figure-eight shape. Once in this configuration, the tendency of the main tent sides will be to flex into their normal circular configurations as constrained by the flexible cover 30. Once the discs 21 are released into their stacked or layered configuration, the tent and canopy structure 10 will unfold into the fully deployed shape defined by the flexible cover 30 and flexible ribs 20, with one embodiment for such fully deployed shaped being shown in FIG. 1.

In a further embodiment, where the tent and canopy structure 10 is formed from a larger set of flexible ribs 20 and larger flexible cover 30, the folding or collapsing process may be repeated to provide for smaller discs. By way of example, the substantially circular flexible ribs 20 may be collapsed into an hour-glass shape or figure eight shape, and then with a slight twisting motion, one half of the figure-eight shape is folded on top of the other half of the figure-eight shape to form two stacked discs. This process may be repeated by pulling the sides of the stacked discs together to form a smaller hourglass or figure eight shape, and then as above, with a slight twisting motion, one half of the figure-eight shape may be folded on top of the other section of the figure-eight shape to now form a stack of four discs. In the same fashion, where the stacked discs are large, and further collapsing is possible, the four stacked discs may be further collapsed and folded to form a stack of eight discs.

With each of these collapsing or folding sets, the size of the collapsed disc is approximately one-half the diameter of the disc section prior to folding. Accordingly, where the original flexible support pole circle is 2 meters in diameter, one folding step results in a collapsed set of discs of approximately 1 meters, and a second folding step results in a further collapsed set of discs of approximately ½ meter.

As shown in FIGS. 1 through 9, and as described above, the flexible cover 30 may be configured with one or more doors 100 and windows 110. The doors 100 are to allow users to easily enter and leave the tent and canopy structure 10. The windows 110 allow the users to see out of the tent structure, and to allow others to see into the tent structure 10. The windows 110 also allow wind to pass through but to still provide a level of protection from sand or other wind-blown objects. The tent structure may also be configured with flexible shades (not shown) that can be positioned over the windows to provide some privacy and to block wind.

In order to balance the elements of strength, durability, and weight, the flexible ribs 20 may be manufactured from any type of resilient thermoplastic or composite material. The flexible cover 30 may be manufactured from most any type of lightweight, flexible textile, such as nylon ripstop or similar types of polyester fabrics. Alternative and additional materials that may be used to manufacture some or the entirety of the flexible cover 30 include polyester, canvas, polyvinylchloride (PVC), polyethylene, as well as other flexible textiles and poly-type materials.

In a similar fashion, one or more cutouts 120 may be incorporated into the cover 30, to allow for release of air pressure when wind blows into the tent and canopy structure 10. Such cutouts help to maintain the tent and canopy structure 10 from inadvertently ballooning like a parachute, and moving when the wind blows and catches within the tent structure 10.

While shown in a particular “igloo” or “pod” configuration in FIGS. 1 through 9, the tent and canopy structure 10 may be designed and configured into most any shape or size, including by way of example, and not by way of limitation, as a cube, cylinder, or a teepee shape. Similarly, the tent and canopy structure 10 may be manufactured in different sizes, including variations in height and width, and as described above, may be manufactured having multiple canopy sections 31.

A further embodiment of the tent and canopy structure 10 may include a floor section 60, as shown in FIG. 4B, that would be attached to the flexible cover 30 and ribs 20, and provide the user with some protection and separation from the ground or soil on which the tent structure 10 is deployed. More particularly, the floor section 60 may be attached to the flexible cover 30 using one or more fasteners 24, which could include, by way of example, hook and loop textiles, buckles, snaps, tie strings, buttons and button holes, or any other similar type of fastening mechanism. Alternatively, the floor section 60 may be manufactured as being integral with the flexible cover 30.

As illustrated in FIGS. 4A and 4B, to provide further separation and protection of the interior of the main tent section 11 from the underside of the vehicle to which the tent and canopy structure 10 is attached, the flexible cover 30 may further incorporate a shade or panel 39 as part of the bottom section of the main tent section 11 from which the canopy section 31 extends. The shade or panel 39 is located to separate and shield the interior of the main tent section 11 from the exterior of the tent, and more particularly to separate and shield the interior of the main tent section 11 from the underside of the vehicle and from dirt, insect, or other similar elements that users would prefer not being within the tent and canopy structure 10.

In a further embodiment of the above ground shade or panel 39, the shade may be variable or extendable to allow a user to raise or lower the shade or panel 39 to meet the bottom edge of the vehicle that is attached to the tent and canopy structure 10. For this embodiment, the adjustable shade or slide 39 allows the tent and canopy structure 10 to be effectively used with a wide variety of vehicles having different ground clearances and heights, and separate the interior of the tent from the underside of the vehicle to which the tent and canopy structure 10 is attached.

As shown and described, the flexible cover 30 may be flexible to allow for ready assembly, disassembly, and storage. The flexible cover 30 may be manufactured from most any type of lightweight, flexible textile, such as nylon ripstop or similar types of polyester fabrics. Alternative and additional materials that may be used to manufacture the flexible cover 30 include polyester, canvas, polyethylene, flexible polyvinyl chloride (PVC), as well as other flexible textiles, synthetic plastic polymers, and poly-type materials.

As an additional feature of another embodiment of the tent and canopy structure 10, the flexible cover 30 could be manufactured to include photochromic features in part or all of the flexible cover 30 surface area. Such photochromic properties would allow the cover 30 to be clear in low light or night conditions, and to be substantially tinted in full light or daylight conditions. The tinting of the cover 30 in full light or daylight provides users with further protection from potentially harmful UV sunlight.

In order to balance strength, durability, and weight, the flexible ribs 20 may be manufactured from any type of resilient thermoplastic or composite material. With the flexible ribs 20 being manufactured from a resilient thermoplastic, the ribs 20 may be readily formed into a figure-8 shape and folded into a compact size for transport and storage. When fully collapsed, the vehicle cargo bay tent structure 10 is designed to be fairly compact, and storable a storage bag or sack (not shown).

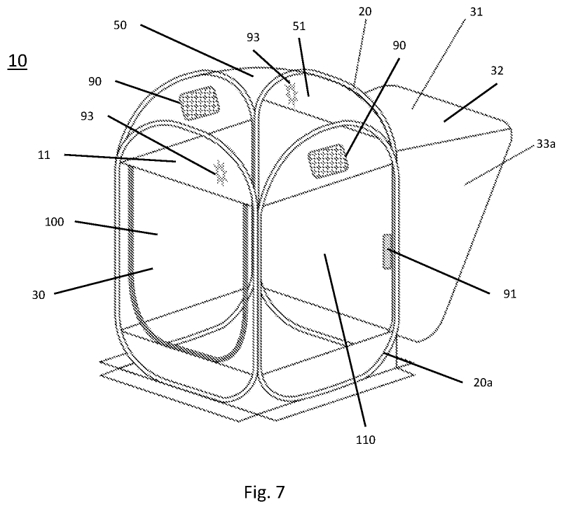

In a further embodiment, incorporating a further enhancement and feature, the tent and canopy structure 10 may incorporate, as shown in FIG. 7, solar panels or photovoltaic (“PV”) panels 90 on or embedded within the flexible cover 30. Such photovoltaic panels 90 may be used to generate electrical power during the day when the panels 90 are exposed to direct or near direct sunlight. The photovoltaic panel 90 electrical power can be used to operate lights 93 or for recharging any type of rechargeable electrical devices.

For improved usability, the tent structure 10 could further include electrical power storage units, such as batteries 91, such that the electrical power generated by the photovoltaic panels 90 during the daylight would be stored in the batteries 91, and then be able to be used to power lights 93 during the evening and night hours. The use of light emitting diodes (LEDs) would provide the most efficient use of electrical power generated by the photovoltaic panels, and would provide additional safety over incandescent bulbs, which tend to generate excess heat.

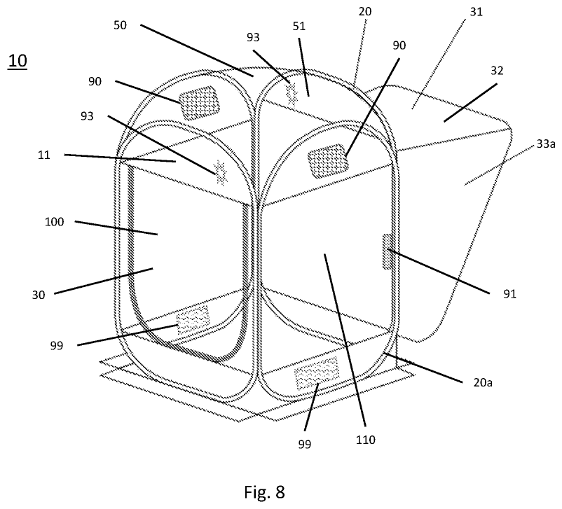

In another embodiment relating, in part, to the above PV panel embodiment, the tent and canopy structure 10 may further incorporate, as shown in FIG. 8, one or more electrical heating elements 99 embedded into one or more sides of the tent structure, or embedded into a floor section of the tent and canopy structure 10. The heating elements 99 may be standard resistor-type or carbon fiber heating elements used within a variety of apparel, blankets, or mats.

When the heating elements 99 are activated, they provide heat and warmth to the interior of the tent and canopy structure 10 for added comfort for the tent occupants. The heating elements 99 may draw electrical power from any available power source, including the tent structure batteries 91, a separate power source (not shown) such as a separate battery, or by drawing electrical power from the vehicle to which the tent structure 10 is attached or connected. The heating elements 99 can be embedded into the flexible cover 30, or attached to the interior of the flexible cover 30 as a separate sheet, mat, or alternatively as a string element to be placed by the user.

In a further embodiment, as suggested above, the tent and canopy structure 10 may include an electrical connection 95 to allow the tent structure 10 to draw electrical power from the vehicle, and thereby power any lights 93, any heating elements 99, or possibly provide power for charging other equipment such as cell phone, tables, and/or laptops. In still a further embodiment, an inverter 97 (not shown) may be incorporated as part of the tent and canopy structure 10 to convert vehicle direct current to alternating current (“AC”), which can then be used to power a variety of appliances such as fans, laptops, monitors, televisions, or other appliances using AC power.

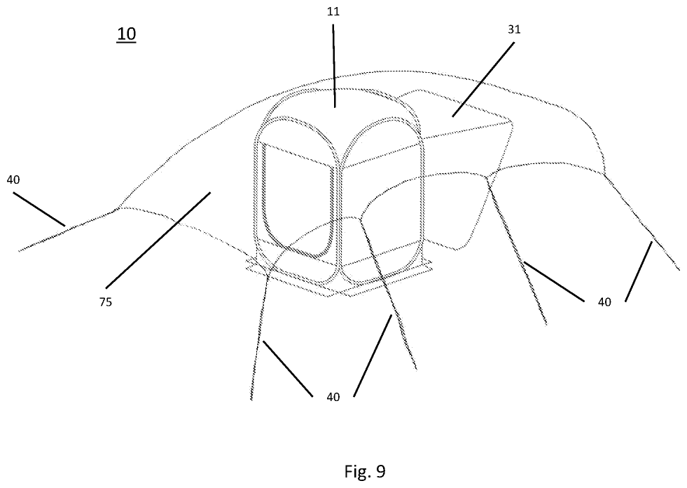

To provide additional protection for the tent structure 10 and users of the tent structure 10, especially from rain or other precipitation, an additional cover sheet 75 may be placed over the deployed tent structure 10, as shown in FIG. 9 (as a transparent cover sheet). The cover sheet 75 may be held in place by guy lines or tie-downs 40 attached to the ground surrounding the tent structure 10 or to any stable surface or structure around the tent structure 10.

To further section the tent and canopy structure 10 when deployed, the tent and canopy structure 10 may also include pockets or bags (not shown) for use to weigh down or provide ballast to the main tent section 11. For example, at the beach, sand can be easily placed in the bag sections, whereas for use with camping or non-beach activities, stones or a plurality of smaller rocks can be placed in the bag sections or pockets to provide additional weight or ballast. When it is time to collapse and transport the tent and canopy structure 10, the sand, stones, or small rocks may be readily removed from the bag sections, and disassembly or folding is easily achieved.

The drawings and disclosed embodiments are but a limited set of examples of how the inventive tent and canopy structure 10 may be used. For example, while the tent structure 10 is described as being deployed adjacent and connected to a motor vehicle, other uses may be equally beneficial or relevant to users. Such other uses may include, without limitation, beach, camping, and other outdoor activities, such as use within a garden, at sporting events, a party shelter, a reading spot, a safe enclosure for pets, a leisure/quiet place, and/or set up and used by various commercial entities such as temporary covered spots by restaurants, spas, or resorts.

While preferred embodiments of the inventive combined tent and canopy structure 10 for use with motor vehicles have been described and disclosed, in particular by reference to certain figures and exemplary embodiments relating to particular shapes, sizes, and configurations for the tent structure 10, such embodiments for the tent structure 10, are not to be construed as limiting the scope of application of the inventive devices or systems. For example, as described and claimed, the combined tent and canopy structure 10 may be configured to have more than one canopy section 31, thereby allowing for multiple vehicles to be interconnected in a tailgate fashion. Moreover, other variations to the tent structure 10 may include different shapes, including pentagon, octagon, or other geometric shapes, and/or with the tent structure having multiple doors or windows incorporated into the cover 30. All such alternate embodiments are deemed to be within the scope of the inventive design and below claims.

It will be recognized by those skilled in the art that other modifications, substitutions, and/or other applications are possible, and all such modifications, substitutions and applications are within the true scope and spirit of the present invention. It is likewise understood that the above disclosure and attached claims are intended to cover all such modifications, substitutions, and/or applications.

What is claimed is:

1. A combined tent and canopy structure for use with motor vehicles, comprising:
A plurality of flexible ribs that form a skeletal shape for a main section of said tent structure;
A flexible cover attachable to said plurality of flexible ribs to form said main section of said combined tent and canopy structure, and forming at least one canopy sleeve section extending from sides of said tent main section, wherein at least one canopy sleeve is sized to encircle at least three sides of a section of said motor vehicle;
A plurality of connecting straps, having an adjustable strap length, wherein one end of each of said plurality of connecting straps is attached to said flexible cover, and wherein the opposite end of each of said plurality of connecting straps is attachable to a fixed element of said motor vehicle, such that when said plurality of connecting straps are connected to said motor vehicle, a connecting canopy is formed between said main section of said tent structure and said motor vehicle; and
A plurality of tie-down elements to attach said plurality of flexible ribs and said flexible cover to a stable element.

2. The combined tent and canopy structure, as described in claim 1, wherein said tent structure further comprises at least one openable door within said flexible cover.

3. The combined tent and canopy structure, as described in claim 1, wherein said tent structure further comprises at least one openable window within said flexible cover.

4. The combined tent and canopy structure, as described in claim 1, wherein said plurality of flexible ribs are manufactured from at least one of thermoplastic material, aluminum, steel, and fiberglass.

5. The combined tent and canopy structure, as described in claim 1, wherein said flexible cover is partially formed from at least one of nylon ripstop material, canvas material, synthetic plastic polymer including at least one of a polyethylene material and a polyvinyl chloride material.

6. The combined tent and canopy structure, as described in claim 1, wherein said plurality of connecting straps are manufactured from an elastomer whereby said plurality of connecting straps may extend 30% from a non-extended configuration.

7. The combined tent and canopy structure, as described in claim 1, wherein said tent structure main section further comprises a transparent top section.

8. The combined tent and canopy structure, as described in claim 1, wherein said flexible cover has photochromic features for at least 50% of a roof section of said flexible cover, such that said roof section is clear in low light or night conditions, and is substantially tinted in full light or daylight conditions.

9. The combined tent and canopy structure, as described in claim 1, further comprising at least one photovoltaic panel attachable to at least a portion of said tent structure roof section.

10. The combined tent and canopy structure, as described in claim 9, further comprising at least one light emitting diode electrically connected to said at least one photovoltaic panel.

11. The combined tent and canopy structure, as described in claim 9, further comprising at least one energy storage device to store electrical power generated by said at least one photovoltaic panel.

12. The combined tent and canopy structure, as described in claim 1, further comprising at least one heating element embedded within at least one side of said tent structure or embedded within a floor section of said tent structure.

13. The combined tent and canopy structure, as described in claim 1, further comprising an electrical connector to draw electrical power from said motor vehicle.

14. The combined tent and canopy structure, as described in claim 1, wherein said flexible cover forms two canopy sleeve sections extending from opposites sides of said tent main section, such that said two canopy sleeve sections attach to two separate motor vehicles diametrically opposed to each other.

15. The combined tent and canopy structure, as described in claim 1, further comprising a separation panel located across the bottom of the tent main section side from which said canopy sleeve extends.

16. The combined tent and canopy structure, as described in claim 15, wherein said separation panel is an extendable shade attachable to the bottom of the motor vehicle to which said canopy sleeve is attached.

17. A combined tent and canopy structure for use to extend the interior of motor vehicles, comprising:
A tent main section formed from
a plurality of flexible ribs;
a tent cover attachable to said plurality of flexible ribs;
At least one canopy section formed from
a canopy cover integrally attached to and extending away from a side of said tent cover, wherein a distal end of said canopy cover encircles a section of said motor vehicle and provides a covered area between the interior of said motor vehicle and the interior of said tent main section;
A plurality of connecting straps, having an adjustable strap length, wherein one end of each of said plurality of connecting straps is attached to said tent cover or canopy cover, and wherein the opposite end of each of said plurality of connecting straps is attachable to a fixed element of said motor vehicle; and
A plurality of tie-down elements to attach said plurality of flexible ribs and said tent cover to a fixed surface.

18. The combined tent and canopy structure, as described in claim 17, wherein said tent and canopy structure further comprises at least one openable door at an end of said entryway of said tent structure.

19. The combined tent and canopy structure, as described in claim 17, wherein said tent and canopy structure further comprise at least one openable window within said cover.

20. The combined tent and canopy structure, as described in claim 17, wherein said plurality of flexible ribs are manufactured from at least one of thermoplastic material, aluminum, steel, and fiberglass.

21. The combined tent and canopy structure, as described in claim 17, wherein said cover is at least partially formed from at least one of nylon ripstop material, canvas material, a synthetic plastic polymer including at least one of a polyethylene material and a polyvinyl chloride material.

22. The combined tent and canopy structure, as described in claim 17, further comprising at least one heating element embedded within at least one side of said tent structure or embedded within a floor section of said tent structure.

23. The combined tent and canopy structure, as described in claim 17, further comprising an electrical connector to draw electrical power from said motor vehicle.

24. The combined tent and canopy structure, as described in claim 17, further comprising at least one photovoltaic panel attachable to at least a portion of said tent main section roof.

25. The combined tent and canopy structure, as described in claim 24, further comprising at least one light emitting diode electrically connected to said at least one photovoltaic panel.

26. The combined tent and canopy structure, as described in claim 24, further comprising at least one energy storage device to store electrical power generated by said at least one photovoltaic panel.

27. The combined tent and canopy structure, as described in claim 24, wherein two canopy covers form respective canopy sleeve sections extending from opposites sides of said tent main section, such that said two canopy sleeve sections attach to two separate motor vehicles diametrically opposed to each other.
